(19) United States
(12) Patent Application Publication
(10) Pub. No.: US 2012/0039395 A1
(43) Pub. Date: Feb. 16, 2012

(54) SYSTEM AND METHOD FOR TIME SERIES FILTERING AND DATA REDUCTION

(75) Inventors: Robert J. Jannarone, Atlanta, GA (US); John T. Tatum, Atlanta, GA (US); Thuy Xuan Cox, Atlanta, GA (US); Leronzo Lidell Taturn, Atlanta, GA (US); David J. Cohen, Atlanta, GA (US)

(73) Assignee: BRAINLIKE, INC., Atlanta, GA (US)

(21) Appl. No.: 12/999,616

(22) PCT Filed: Mar. 24, 2010
(86) PCT No.: PCT/US10/28501

§ 371 Date: Oct. 11, 2011

Related U.S. Application Data
(62) Division of application No. 61/254,393, filed on Oct. 23, 2009.
Application No. 61/254,393 is a division of application No. 61/162,824, filed on Mar. 24, 2009.

(51) Int. Cl. H04N 7/30

(52) U.S. Cl. 375/240.18; 375/E07.226

(57) ABSTRACT

The present invention is be directed to systems and methods that efficiently reduce cluttered data and identify useful information, in real-time. The disclosed auto-adaptive system distinguishes target data in data sets from clutter data that causes low target hit rates and high false alarm rates. Data set features may then be modified to account for changes over time, resulting in auto-adaptive alarm thresholds, higher target hits rates, and lower false alarm rates. In addition, data may be reduced to snip containing target information, while excluding large amounts of clutter data. Thereby, real-time data can be more readily understood and transmitted data can be reduced.

### BACKGROUND

1. Field of the Invention

The subject matter of the present application relates generally to removing image, audio, and other sensor clutter in real-time and, more specifically, to a system and method for continuously learning clutter metrics under changing conditions to allow events of interest to be identified accurately, thereby allowing for efficient clutter filtering reduction in transmitted data.

2. Related Art

Auto-adaptive systems have many applications. These applications include event recognition based on data measured over a number of successive time periods. Events take many different forms. For example, events may include detection of a target in a particular area, sensing of an out-of-specification condition in a physical environment or correspondence of processed psychometric measurements with a particular behavior prediction profile. Anomaly sensing is often an element of detecting an event. Event recognition may also comprise evaluation of sensed data to recognize or reject the existence of conditions indicated by the data or to initiate a particular action.

One use of event detection is in military operations. When making critical combat decisions, a commander must often decide to either act at once or hold off and get more information. Immediate action may offer tactical advantages and improve success prospects, but it could also lead to heavy losses. Getting more data may improve situational awareness and avoid heavy losses, but resulting delays may cause other problems. Making the right choice depends strongly on knowing how much could be gained from gathering more information, and how much could be lost by delaying action.

In conventional solutions, data is collected in the field by sensors of one kind or another. In the context of the present description, a sensor is an item that provides information that may be used to produce a meaningful result. Data is collected over successive time periods, generally from an array of sensors. Depending on the conditions being analyzed and the type of sensors utilized, different types of data points may be established. For example, a data point characterizing a position of a point in a plane may be characterized by x and y coordinates. Such a point has two spatial dimensions. Other dimensions may also exist. For example, if the data point describes the condition of a pixel in a television display, the data point may be further characterized by values of luminance and chroma. Alternatively, if the data point describes audio content the data point may be characterized by frequency and volume. These values are characterized as data points along further dimensions.

In order to describe an environment mathematically, adaptive algorithms process successive signals in one or a plurality of dimensions to converge on a model of the background environment to track the background's dynamic change. When an event occurs within a sensor's area of response (e.g., within a field of view of optical sensors or within reception of an audio sensor), the adaptive algorithms determine if the return is sufficiently different from the background prediction. Domain specific event identification algorithms may then be applied to verify if an event has occurred while minimizing the likelihood and number of false positives and reducing the cost of transmitting unnecessary information.

An important aspect of the adaptive algorithm approach is a dynamic detection threshold that enables these systems to find signals and events that could otherwise be distinguished from noise in a naturally changing environment. Having a dynamic threshold also allows a system to maintain a tighter range on alarm limits. Broader alarm ranges decrease the power of the system to distinguish anomalous conditions from normal conditions.

Conventional event detection systems have many known drawbacks and require powerful processors rather than the simpler, less expensive field programmable gating arrays (“FPGAs”) that are desirable for field deployment. Additionally, many conventional event detection systems are developed using higher level programming language (e.g., C++), which is effective but slow in comparison to the simple instructions used for FPGAs. However, as new unmanned vehicles are being developed that are smaller, more agile, and have the capability of reaching places that have not been reached before, the demands made upon the data processing capabilities of these conventional systems have increased dramatically.

Conventional event detection systems also lack efficient ways of handling large arrays of data. In many applications, processors in the field will need to respond to large data sets output from a large number of sensors. The sensors will be producing consecutive outputs at a high frequency. Conventional systems process these data sets using the inverse of a covariance matrix, which is a highly complex calculation, especially when the number of covariates is large. Additionally, these conventional event detection systems are designed to handle event detection and adaptive learning after entire sets of data have been collected, which is extremely inefficient and undesirable in field deployed applications. Furthermore, conventional systems fail to incorporate risk analysis when processing data sets in the field. Accordingly, what is needed is a system and method that overcomes these significant problems found in the conventional systems as described above.

Therefore, what is needed is a system and method that overcomes these significant problems found in the conventional systems as described above.

### SUMMARY

Embodiments of the present invention may include auto-adaptive systems that distinguish target data in data sets from clutter data that causes false alarms. Data set features may then be modified to account for identified false alarms/clutter data by the auto-adaptive system by changing the weight or values associated with various data components. Embodiments may also include a risk analyzer to process data related to hit rates, false alarm rates, alarm costs, and risk factors to determine certain return on investment information, and certain hit versus false alarm curves—also referred to herein as receiver operator characteristic (“ROC”) curves.

Embodiments of the present invention provide for an operation referred to as auto-adaptive processing. Auto-adaptive processing is not a recognized term of art, but is descriptive of processing of data, often condition-responsive data received from one or more of sensors in successive time slices or data groups, in order to update adaptive functions and to calculate imputed values of data for use in evaluating and removing clutter from data. The embodiment may operate on time slices which may include clock periods or data cycles, groups of images in time periods, etc. For each time slice, measurement values and measurement plausibility values are supplied to the system, and a learning weight is either supplied to or generated by the system. Alternatively, the system may operate on windows or data sets derived by subdivided data such as portions or groups of one or more images, as well as a number of consecutive time slices.

Auto-adaptive processing operations may include converting measurement values to feature values; converting measurement plausibility values to feature plausibility values; using each plausibility value to determine missing value statuses of each feature value; using non-missing feature values to update parameter learning; imputing each missing feature value from non-missing feature values and/or prior learning; converting imputed feature values to output-imputed measurement values; and supplying a variety of feature value and feature function monitoring and interpretation statistics.

The above operations are performed by applying functions to selected data sets. Embodiments of the present invention may utilize “windowing” functions in order to select successive groups of data entries for processing. Field programmable windowed functionality can be applied to many applications by programming the data entries to be utilized for a calculation and to set parameters of algorithms. Alternatively, the embodiment may separate data into snippets representing consecutive time periods.

Embodiments of the present invention in one form provide for the option of embodying an auto-adaptive processor in the form of parallel, pipelined adaptive feature processor modules that perform operations concurrently. Tasks including function monitoring, interpretation and refinement operations are done in parallel. Distribution of tasks into modules permits the use of simplified hardware such as FPGAs, as opposed to full processors in various stages. Auto-adaptive processing may be utilized for tasks that were previously considered to be intractable in real time on hardware of the type used in low powered, portable processors. The option of modular pipelined operation simplifies programming; design and packaging and allows for use of FPGAs in place of high-powered processors. Stationary learned parameter usage, based on the same estimation functions and learned parameter values, can be used to produce the estimates that in turn allow unexpected events to be detected more simply.

Embodiments of the present invention may be used in a wide variety of applications. These applications include disease control, military attack prevention, monitoring personnel, measuring efficacy of antibiotics, detecting and monitoring system performance to prevent breakdowns. Event recognition may be used to trigger an alarm and initiate a response or produce a wide variety of other reactive or proactive responses. In one application, usability of data is evaluated so that a remote device may decide whether or not to utilize its limited power and bandwidth to transmit the data.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1A illustrates a first embodiment employing an unmanned aerial vehicle (“UAV”) as part of an intelligence system in accordance with the present invention.

FIG. 1B illustrates a block diagram of an embodiment employing a field user, as part of an intelligence system in accordance with the present invention.

FIG. 2 is a block diagram of the system incorporating a first embodiment of the present invention.

FIG. 3 illustrates an example of one of several camera images generated in accordance with the first embodiment.

FIG. 4 illustrates a masked counterpart to FIG. 3.

FIG. 5 illustrates an example of one of several camera images generated in accordance with the first embodiment.

FIG. 6 illustrates an example of an identified feature in the camera images shown in FIG. 5.

FIG. 7A is a flowchart of a first method for performing time-series filtering and data reduction in accordance with the first embodiment.

FIG. 7B is a flowchart of a second method for performing time-series filtering and data reduction in accordance with the first embodiment.

FIG. 8 illustrates a second embodiment employing a wireless sender and receiver, as part of an intelligence system in accordance with the present invention.

FIG. 9A is a flowchart of a first method for performing time-series filtering and data reduction in accordance with the second embodiment.

FIG. 9B is a flowchart of a second method for performing time-series filtering and data reduction in accordance with the second embodiment.

FIG. 9C is a flowchart of a third method for performing time-series filtering and data reduction in accordance with the second embodiment.

FIG. 9D is a flowchart of a fourth method for performing time-series filtering and data reduction in accordance with the second embodiment.

FIG. 10 is a block diagram illustrating an example wireless communication device that may be used in connection with various embodiments described herein; and

FIG. 11 is a block diagram illustrating an example computer system that may be used in connection with various embodiments described herein.

### DETAILED DESCRIPTION

After reading this description, it will become apparent to one skilled in the art how to implement the invention in various alternative embodiments and in alternative applications. However, although various embodiments of the present invention will be described herein, it is understood that these embodiments are presented by way of example only, and not by way of limitation. As such, this detailed description of various alternative embodiments should not be construed to limit the scope or breadth of the present invention as set forth in the appended claims.

Example embodiments of the present invention may be directed to systems and methods that efficiently reduce cluttered data and identify useful information, in real-time. Accordingly, real-time data can be more readily understood and transmitted data can be reduced.

Imaging Embodiment

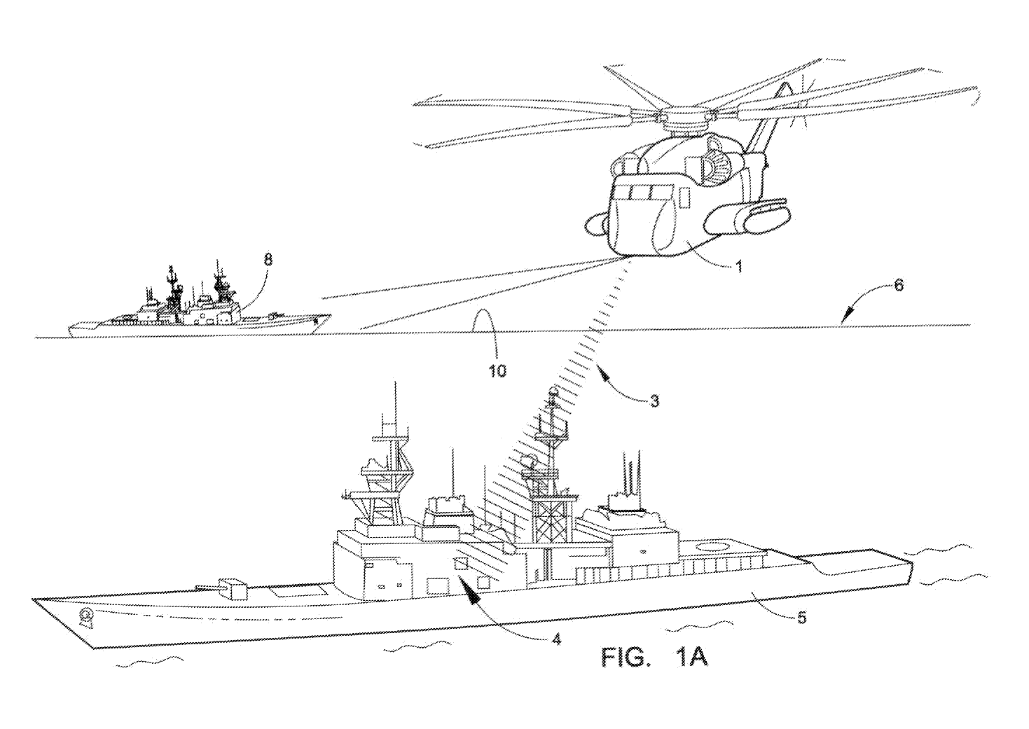

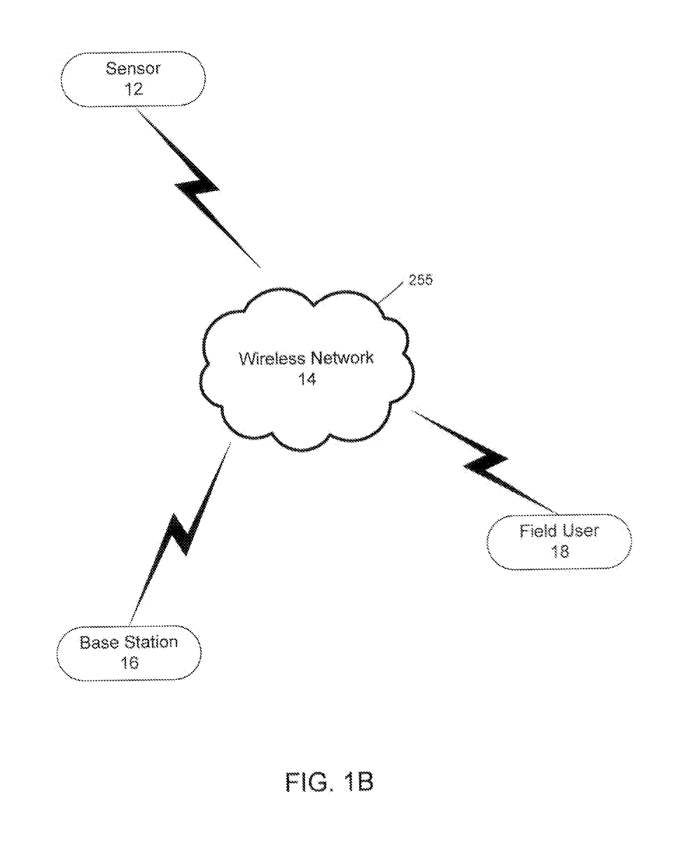

In the present description, FIGS. 1-3 describe one embodiment of a physical hardware system within which the system may be implemented.

FIG. 1A illustrates a first embodiment of the present invention employing a UAV 1 as part of an intelligence system. UAV 1 may include an array of sensors, processors and a transmitter, further described and illustrated below. UAV 1 may provide video information via a radio frequency link 3 to a base station 4. In the present illustration, base station 4 may be housed in a ship 5. Ship 5 may be traveling in an ocean 6. UAV 1 may detect enemy craft 8. Enemy craft 8 may be beyond a horizon 10 of ship 5. The transmitter within UAV 1 must have sufficient bandwidth to provide detected video information to base station 4. Data processing equipment and transmitter modulation circuitry must have sufficient capacity to transmit video information. UAV 1 may include processing systems to ensure that video information provided by the UAV 1 to the base station 4 is useful. To the extent that UAV 1 transmits non-useful information, UAV 1 will unnecessarily expend resources. To the extent that base station 4 will be receiving non-useful information, base station 4 will have to expend resources to cull the non-useful information. Processing of non-useful information at base station 4 will also slow the response to useful information.

Ambient conditions will have a tendency to obscure the view of the enemy craft 8 from the UAV 1. Moisture in the air is a common ambient condition. Very often, moisture in the air will not be sufficient to block obtaining a useful image. Optical filtering may also be used to reduce haze. However, clouds or rainstorms may be located between enemy craft 8 and UAV 1. The video data obtained when enemy craft 8 are not viewable is referred to in the present description as non-useful information. Commonly, UAVs simply collect data and transmit the data to a base station, therefore, UAV 1 must have sufficient resources to transmit all its captured data, including both non-useful and useful information. In accordance with embodiments of the present invention, data processing is done to determine whether information obtained by UAV 1 is useful or not. One criterion that needs be evaluated to determine whether information is useful is a contrast level in an image sensed by UAV 1. An image of cloud cover will have low contrast, while a useful image of enemy craft 8 will include objects that have contrast with respect to their backgrounds. By preventing transmission of non-useful information, circuitry in UAV 1 may be designed to have less robust transmission circuitry and lower power requirements than UAV 1 needs to transmit all of its information. Further benefits may include sufficient bandwidth for a more complete transmission over available bandwidth and lower bandwidth requirements. The resulting decrease in total transmission of information permits the use of simpler circuitry and lowers power requirements. The efficiency and reliability of processing at base station 4 is also increased.

FIG. 1B illustrates a variation on the first embodiment of the present invention, employing a field user 18 as part of an intelligence system. Sensor 12 may include UAV 1 or some other monitoring or sensor device or vehicle. Sensor 12 may provide information to a base station 16 via a wireless network 14. Base station 16 may be located in any location capable of housing sufficient processes to manage the data provided by sensor 12. For example, base station 16 may be housed on a ship, a bunker, aircraft, satellite, etc. Sensor 12 may include a transmitter having sufficient bandwidth to provide detected information to base station 16. Sensor 12 may also include processing systems to ensure that video information provided by sensor 12 to the base station 16 is useful. To the extent that sensor 12 transmits non-useful information, sensor 12 and base station 16 will unnecessarily expend resources.

Base station 16 may also be in communication with field user 18. Field user 18 may be in communication with base station 16 via wireless network 14 or via another communication media, such as a separate wireless or wired network, cellular network, etc. Field user 18 may receive, decompress, and display the data from sensor 12 in real-time. Field user 18 may also send configuration packets to the base station 14 and/or sensor 12. These configuration packets may include feature specifications, sensitivity metrics, and other sensing information that may be communicated to the sensor and/or may aid in identifying useful information and/or masking clutter.

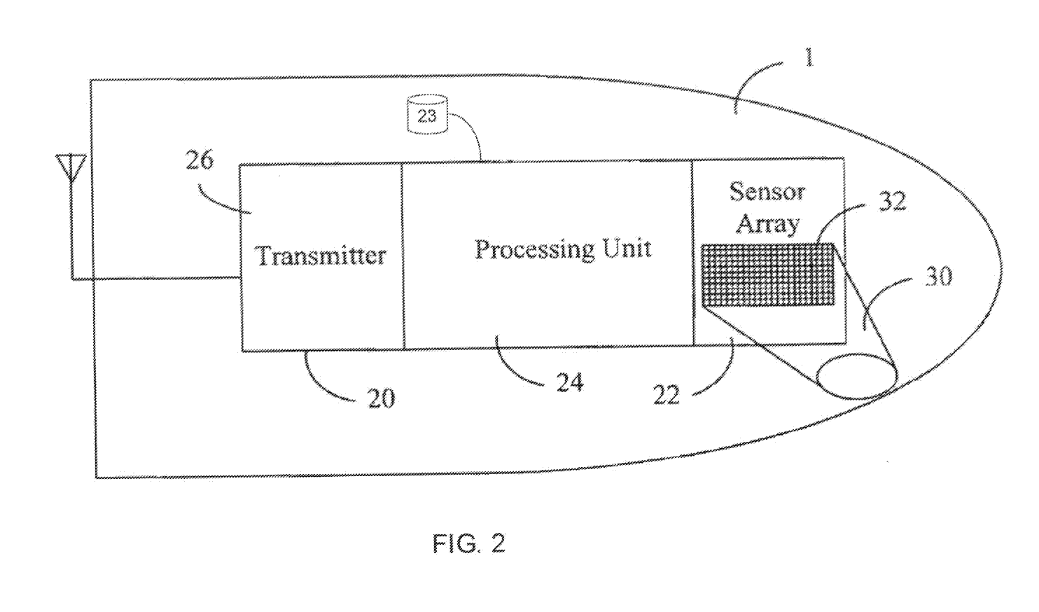

The example embodiment may perform adaptive learning in real-time. A general block diagram of the system incorporating an embodiment of the present invention is shown in FIG. 2. UAV 1 may comprise an electronics unit 20 including a sensor array 22, a processing unit 24, a data storage area 23, and a transmitter 26. In the present illustration, sensor array 22 comprises a video camera 30 having an array of pixels 32, each providing an output indicative of light focused on the pixel 32. Sensor array 22 may provide data to processing unit 24. Processing unit 24 may provide video output to transmitter 26. Data storage area 23 provides persistent and volatile storage of information for use by the various components of the system. Certain embodiments may process measurements that are one-dimensional or multi-dimensional. For example, a one-dimensional output could comprise a gray-scale level wherein a single value is indicative of pixel output. Alternatively, a plurality of values may represent output of one pixel, such as gray-scale level and color levels. In one embodiment, input values can be arranged in four dimensions, e.g., three space dimensions and one feature dimension and each of these dimensions can have one or more slices. The number of effective dimensions is the number of dimensions having more than one slice. Accordingly, if more than one feature is measured on a two dimensional image, then the feature dimension has more than one slice. Advantageously, the feature dimension can also have more than one slice if, for example, the same features within a grid are measured by different cameras. Additionally, in one embodiment windows can have up to five dimensions, the three space dimensions, the feature dimension, and a time dimension.

The present embodiments may achieve the necessary functions to produce meaningful output data as in the prior art. However, as further described below, the present embodiments will have a greater generality, efficiency, and affordability as compared to prior art in embodiments. Since speed and capacity of the system are vastly improved with respect to the prior art, a depth of processing is made available in applications where it could not be used before, for example, real-time video processing of entire rasters at many frames per second. New market segments for adaptive processing are enabled.

The example embodiment may gather data from successive time slices. The greater the temporal resolution of the data gathered, the shorter the period of each time slice. The functions performed by the present embodiments include receiving input values in consecutive time slices and performing processing operations during each time slice. These operations may include estimating each input value from current and prior input values through the use of a correlation matrix; comparing each estimated value to its actual value to determine whether or not the actual value is deviant; replacing deviant or missing input values with their estimated values as appropriate; and updating learned parameters. Updating all learned parameters is important, because it allows event recognition criteria to be continuously, automatically, and adaptively updated over time.

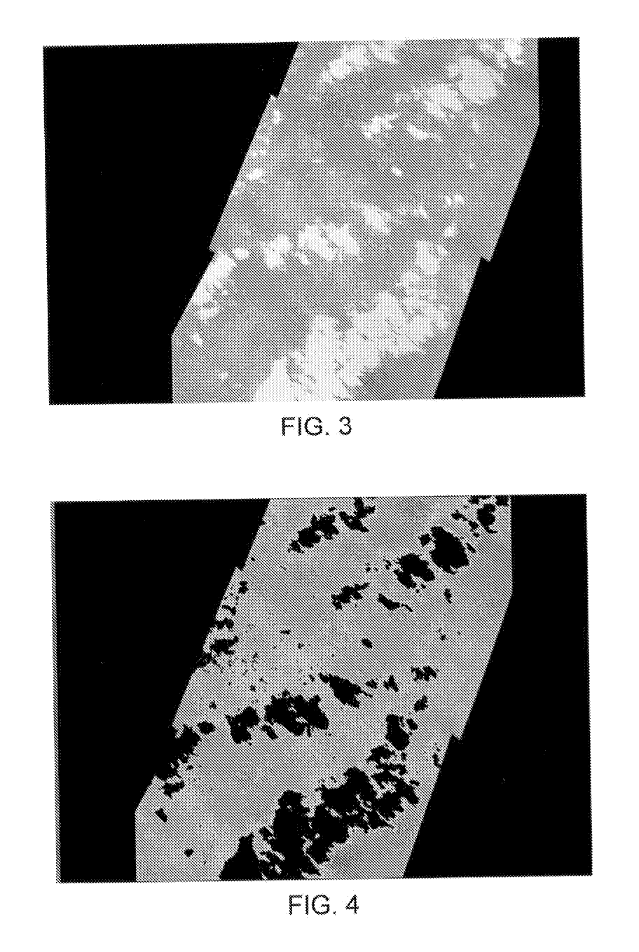

FIG. 3 illustrates an example of one of several camera images generated by UAV 1 in accordance with the first embodiment. A time series consisting of many such images may be captured at a rate of, for example, eight images per second from a camera turret residing on UAV1. The turret may contain six, slightly overlapping cameras. A GPS-based controller may serve to register each image as being in the same geographic area. In FIG. 3, part of the frame is covered by only three different cameras on the turret. Each image was made up of 800 by 800 pixels, each having an 8-bit gray scale value. The black regions on both sides of the image represent areas that were not covered by any of the cameras in the turret.

In FIG. 3, a 10 by 10 window size was configured for cloud detection. Feature values were computed for each such window by summing its 100 window values. Similarly, a 5 by 5 window size was configured for wake detection. Feature values were computed for each such window by summing its 9 internal pixel values and subtracting its 16 external pixel values. For both cloud detection and wake detection windows, cutoff values were chosen that effectively and robustly distinguished clutter pixels from others in each frame.

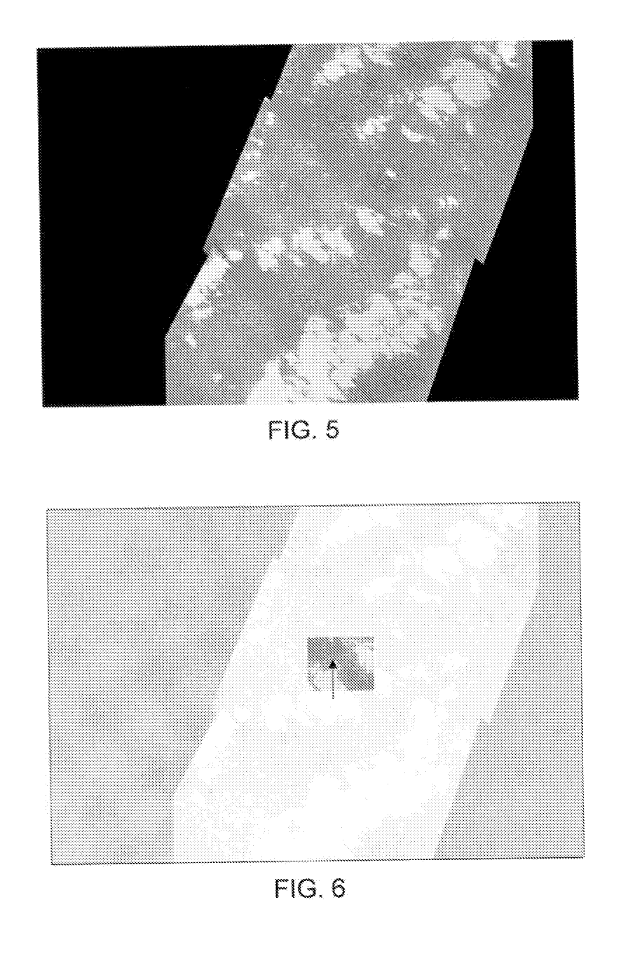

FIG. 4 shows the resulting, masked counterpart to FIG. 3. Once clutter has been masked, events of interest, such as wakes from mammals or vessels, can be detected. For example, the FIG. 3 image contains a simulated wake, which would be difficult to detect either automatically or visually, in the presence of unmasked clutter. However, the wake may be easier to detect once such clutter has been masked, by identifying masked windows still containing white pixels after the cloud masking has been performed. The location of the wake is shown in FIG. 6, next to its corresponding unmasked image, shown in FIG. 5.

The example embodiment may be used either to simplify operator analysis or to reduce data upstream of telemetry, or both. For example, pixel coverage percentage could first be computed in real-time for each processed image like the one shown in FIG. 4, and then used to control transmission and presentation of each frame. Alternatively, averaging could be used to reduce transmitted data, unless windows of interest are identified upstream of telemetry. If such windows are identified, they can be computed in full resolution. For example, pale pixels like those shown in FIG. 6 could be created and transmitted by averaging pixels in non-overlapping windows, covering 100 by 100 by 100 nearest neighbor pixels in space and time. Whenever windows of interest are identified, like the dark image in FIG. 6, they could be transmitted instead of masked. Transmissions could either be triggered by windows exceeding adaptive thresholds or be fixed at a configurable number of windows per frame. For example, the two most target-like windows like the one shown in FIG. 6 could be transmitted once every 10 frames and presented persistently to operators during each 100 consecutive frames. This may result in data compression on the order of 32,000 to one (32,000=[640,000 pixels per frame×10 frames per transmitted window]/(2 transmitted windows per 10 frames×10 rows per window per frame×10 columns per window per frame].

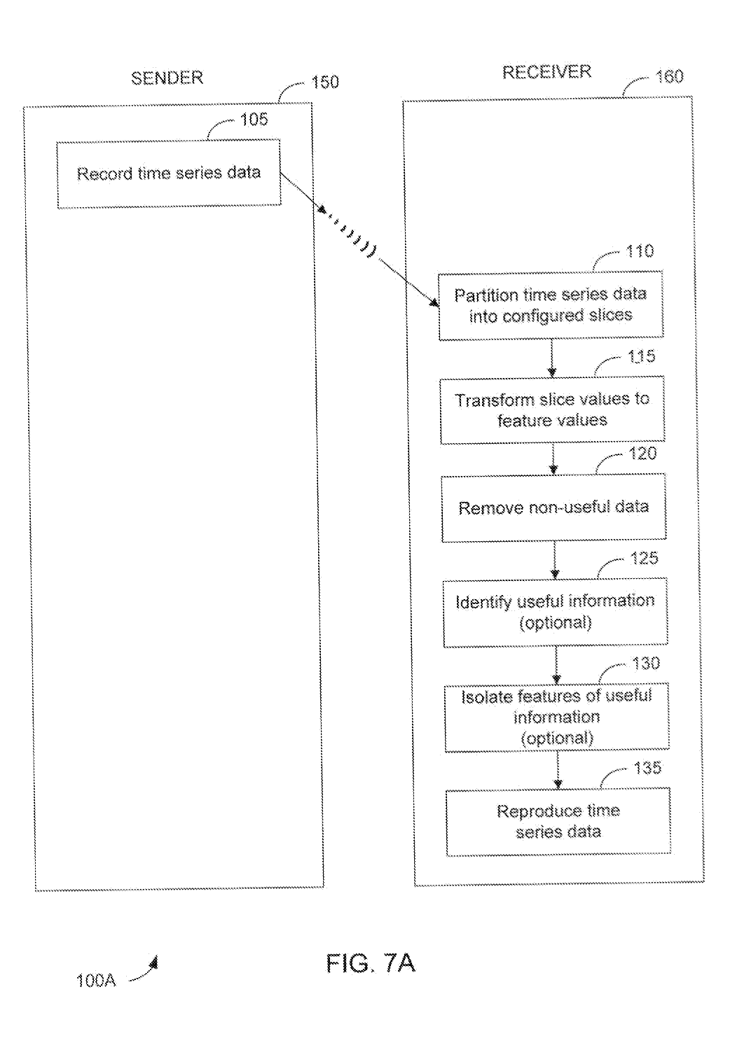

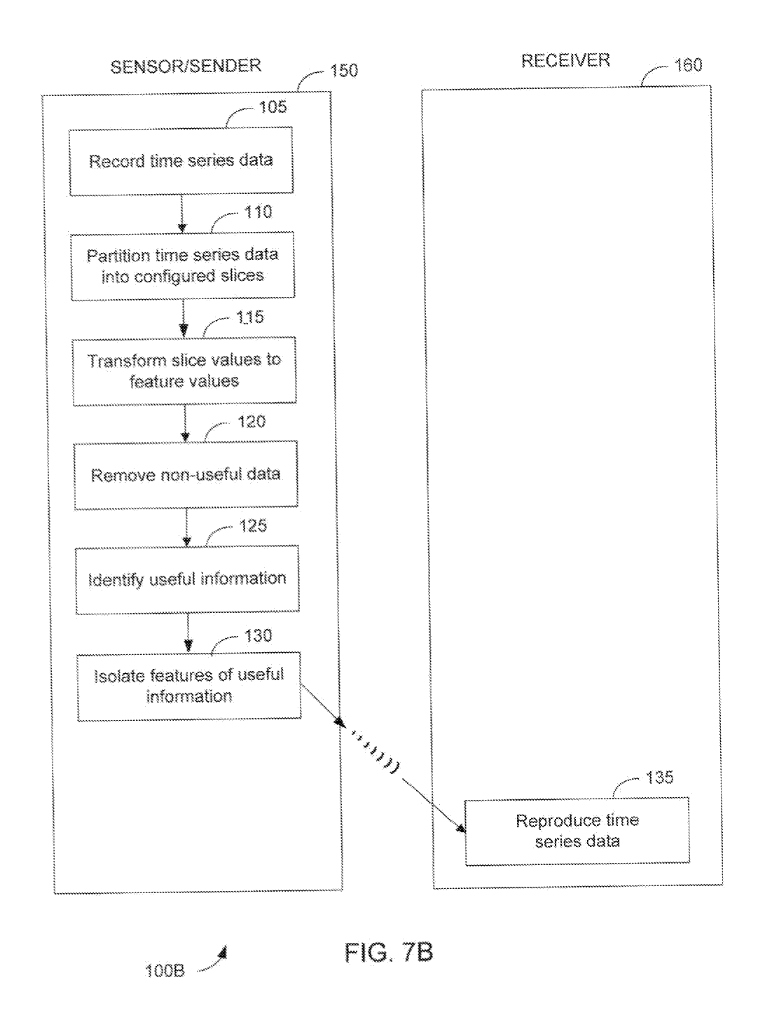

FIG. 7A is a flowchart illustrating a first example method 100A for performing time-series filtering and data reduction. In method 100A, a receiver 160 may filter out clutter in the time series data recorded by sender 150.

At block 105, a sender 150, such as UAV 1, records time series data. Thereafter, the sender 150 would transmit the time series data to receiver 160. Receiver 160 may be, for example, base station 4.

At block 110, receiver 160 may partition the time series data into slices, such as the aforementioned windows, for processing. By dividing the images in windows the system may process the data into manageable data partitions for quick and efficient processing.

At block 115, receiver 160 may evaluate the image windows to identify non-useful portions of data. This may include determining the feature values for portions of the image windows. For example, in the case where the system is masking cloud cover, the system may evaluate sets of 10 by 10 windows. Furthermore, the system may compare the feature values of the 10 by 10 windows to the predetermined values or thresholds associated with cloud cover. Advantageously, the predetermined values may be dynamically calculated and adjusted over time in accordance with the relevant data set. Alternatively, if the system is seeking to identify wakes in the time series input data, the mask identifier module may analyze sets of 5 by 5 windows for feature values associated with wakes. These predetermined values are dynamically determined to effectively and robustly identify noise in the time series data.

At block 120, the system may filter or remove the noise, or simply mark the feature as noise for later processing blocks. Once clutter has been masked, events of interest, such as wakes from mammals or vessels, can be detected. The removal of the non-useful information reduces the later analysis to identify specific features by a significant amount.

In accordance with the above steps in block 105-120, the system may identify non-useful information and thereby filter out clutter and reduce transmitted data. By masking the data from the system identified as containing noise, the system may reduce the image data by removing said noise.

At block 125, the system may compare the feature values assigned to the various slices to predetermined values associated with useful data. These predetermined values are dynamically calculated and adjusted over time to identify desirable features in the unmasked time series data. For example, the system may compare the deviance between the values of the features in the time series data to the expected value ranges of the data. In this way the system can identify unnatural or unexpected phenomena in the time series data. Having removed the noise from the data, it may be easier to identify windows containing features associated with useful data, without generating false alarms.

At block 130, the identified features may be isolated from the remaining time series data. For example, whenever windows of interest are identified, like the image in FIG. 6, they could be transmitted exclusively. By monitoring for changes in windows of interest the system may trigger transmissions when windows change to an extent that exceeds adaptive thresholds. Alternatively or additionally, the system may transmit window updates at a fixed rate, or update a configurable number of windows per transmission.

FIG. 7B is a flowchart illustrating a second example method 100B for performing time-series filtering and data reduction. Under method 100B, a sender 150 may filter out clutter in the time series data. The sender 150 and receiver may divide processing in a way that will both filter out clutter and reduce transmitted data. In process 100B, the sender 150 may partition the data into slices, windows, frames, etc. similarly to process 100A. Blocks 105-335 in process 100A, correspond to the same steps as blocks 105 to 135 in process 100B. However, by shifting blocks 110 to 130 of the processing to sender 150, the system can considerably reduce the amount data transmitted from sender 150 to receiver 160.

The system may then transform the windows to their feature values, and then transmit the feature values. The receiver may then inverse transform the feature values into the time domain to reproduce the time series image data. Sender unit 150 may also continuously update feature salience values, reconfigure the data reduction transforms (as necessary), reproduce the time series data, and transmit reconfigured transforms to receiver 160 in order to ensure proper time domain recovery. Receiver 160 may then play or display the reproduced time series data.

Audio Embodiment

A second embodiment of the present invention may be in combined voice recognition and transmission applications. In voice applications, a person's voice may be hard to understand because of background clutter. In this embodiment, the system may continuously learn how to reduce voice data to a smaller number of feature values that are uniquely salient to a given individual. Once these feature values have been computed and transmitted, they can be transformed back to time domain values to reproduce the individual's same voice, but exclude clutter that was present in the original audio. While many electronic filters are widely used to clarify time series data, the present embodiment may provide added benefits by continuously monitoring and learning an individuals' uniquely salient metrics.

The present embodiment may be implemented on small cell phone or remote sensor processors. Signal processing and computing advances have resulted in highly efficient feature extraction methods such as fast Fourier transforms (FFTs). FFTs are now readily available for low power, compact use on the latest generation of remote sensor and cell phone processors.

With respect to human voice recognition, established methods may convert real-time voice data to snippets, at the phoneme or word level. For example, a partitioning process on a caller's cell phone may first parse a person's voice into snippets. The snippets may average one second in length, when measured in the time domain, may contain an average of 20,000 amplitude values on a one byte gray scale. Established methods may be used to convert those values in the time domain to feature values in other domains. For example, an FFT could transform the 20,000 amplitude values to 20,000 frequency power values, which in turn could be reduced to 1,000 average power feature values. The first such feature value could be the average among frequency power levels between 1 and 20 Hz; the next feature could be the average among power levels between 21 and 40 Hz; and so on.

An available FFT application may reduce data to features in this way on a cell phone, during any given call. During each snippet's time span within the call, the example embodiment may continuously update learned baseline salience values for each such feature. Each salience value may correspond to useful features for accurate voice reproduction. The present embodiment may then use available FFT inverse transforms to convert the salient features of the transmission back to sounds like the sender's voice. If the feature transformation function and inverse transformation function reside on the same cell phone, the output sound will be filtered so that the individual's learned voice will sound more prominent and background clutter will be reduced. If the transformation function resides on a sending cell phone, and the inverse transformation function resides on a receiving cell phone, then transmitted information will be reduced as well, since only feature values, along with occasionally updated configuration values, will require transmission.

The present embodiment may continuously update average feature values associated with an individual and occasionally send a configuration packet, containing the corresponding most salient frequency ranges for that individual. Meanwhile, for each packet the sending phone would transmit only the power levels for those 1,000 frequency ranges on a one byte gray scale. Reducing the audio transmission from 20 k frequencies to 1 k frequencies, resulting data reduction would approach a ratio of 20 to 1, depending on how often update configuration packets are sent. Such update packets may include 1,000 two byte words, pointing to the most salient features among as many as 2¹⁶=65,536 possible features. Alternatively, update packets may be sent with every set of feature values, resulting in a data compression ratio of only 20 to 3. In practice, the update packet would need to be transmitted rarely, resulting in an overall data compression ratio of nearly 20 to 1.

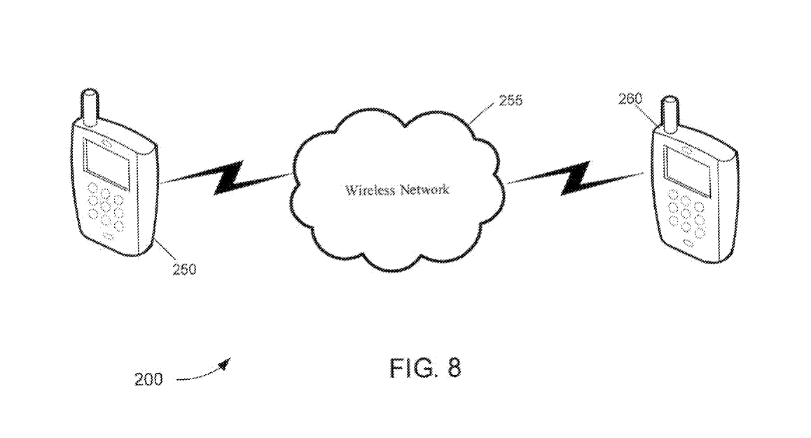

FIG. 8 illustrates an example embodiment of an audio system 200 employed by a transmission method in accordance with the present invention. Audio system 200 may include a sensing/sending unit 250 which transmits data over wireless network 255 to receiver unit 260. Wireless network 255 may be a cellular network, wireless LAN, or simply over the air via a protocol shared by sending unit 250 and receiver unit 260. Sender unit 250 may include hardware to record data in the time domain. Sender 250 or receiver 260 may then perform various operations to remove clutter and reduce the transmitted data, or the receiver may perform any or all of these operations.

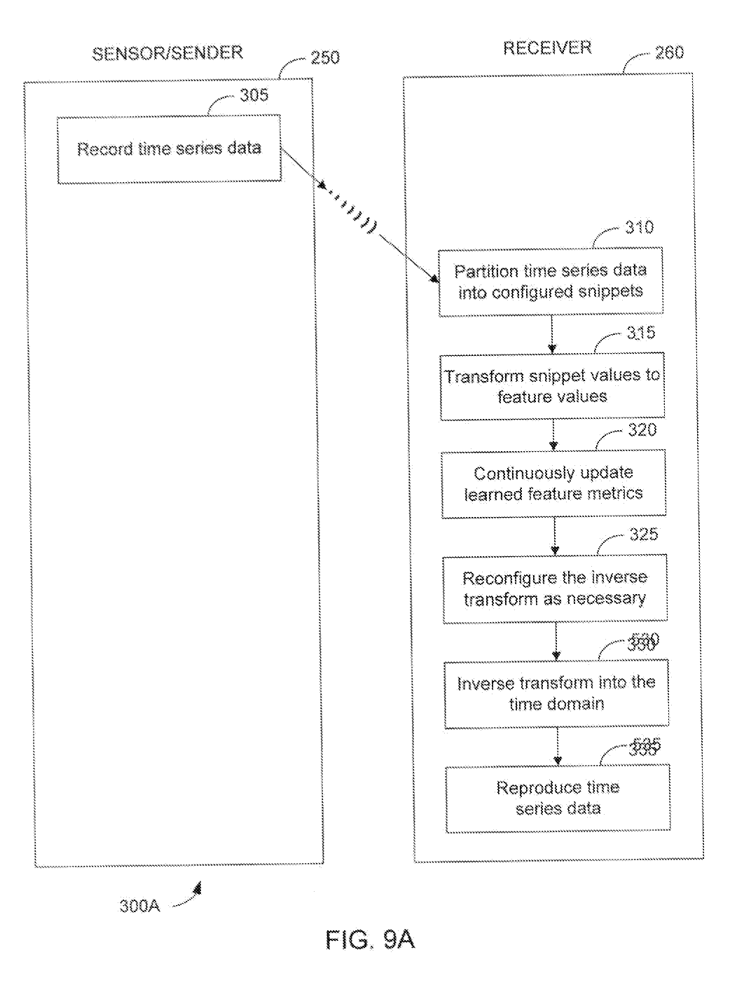

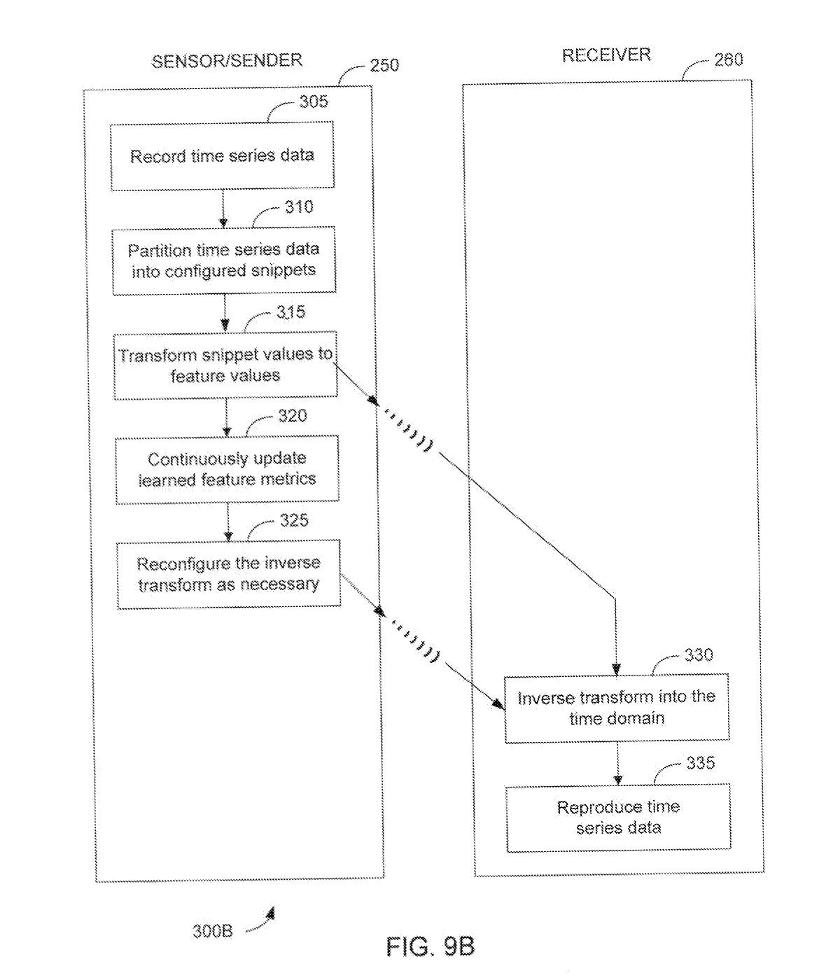

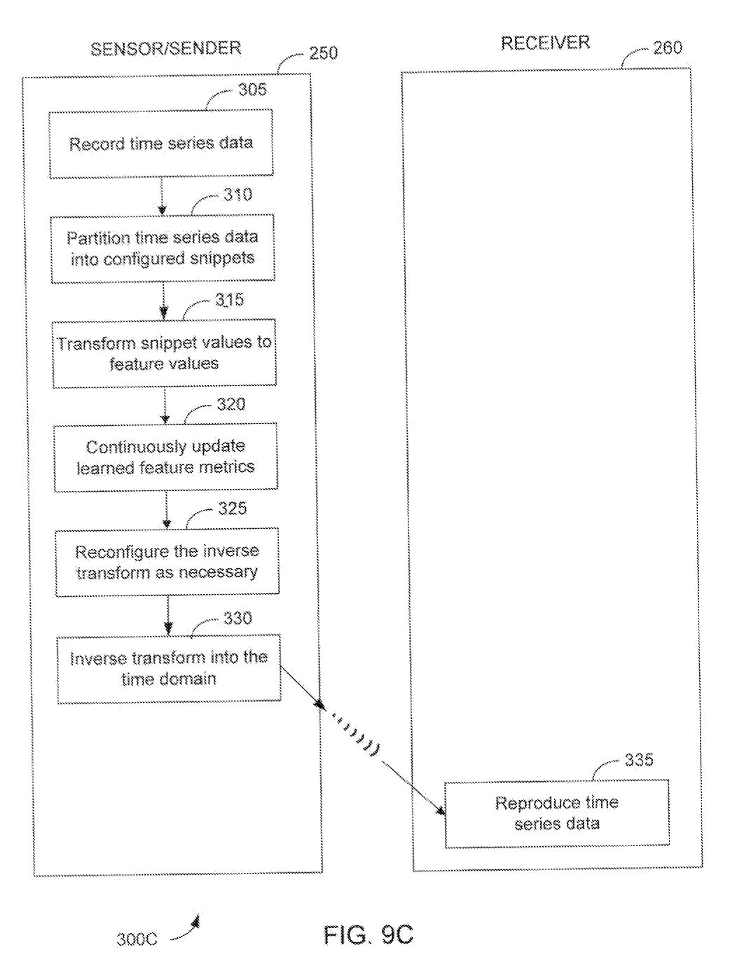

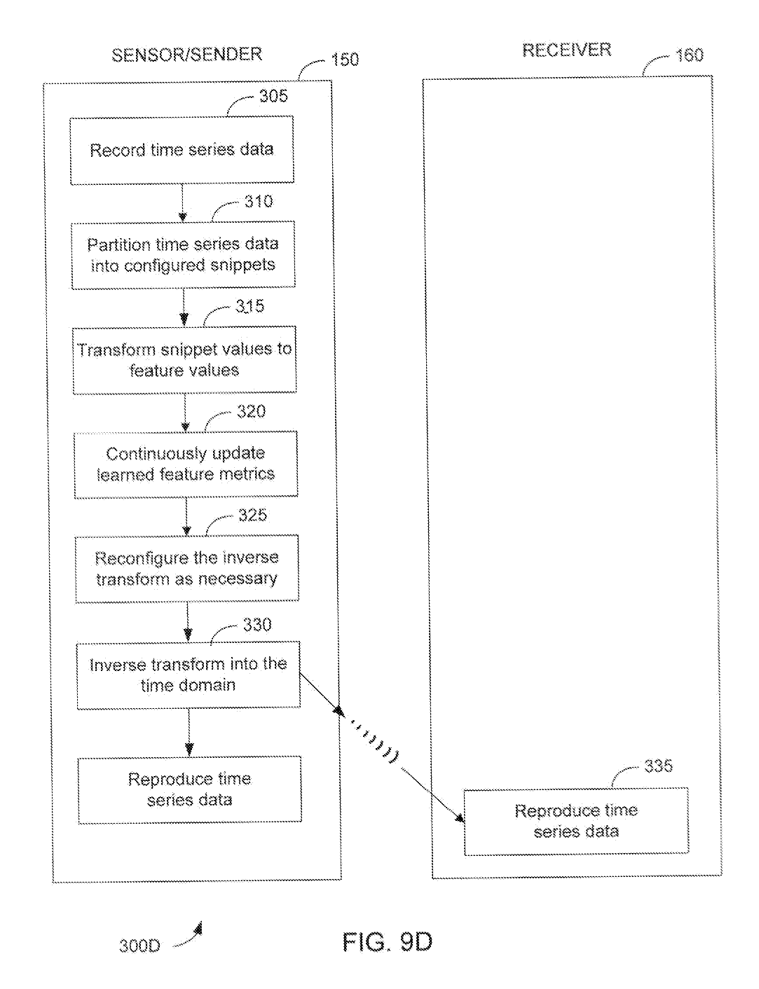

FIG. 9A illustrates an example method 300A, where sender 250 may transmit all recorded data in the time domain to receiver 260. FIG. 9A provides a similar method to method 300A, but focuses on audio frequency transmissions.

At block 305, the sender 250 may record time series data via a hardware component. For example, if sender 250 is an audio transmission device, the time series data may be audio data. Alternatively, if sender 250 is another device, sender 250 may record a different type of frequency data. For example, if sender 250 is a device for measuring vital signs, the frequency data may include pulse and temperature readings. Alternatively, if the sender 250 is a geological monitoring device the frequency data may include seismographic readings.

At block 310, receiver 260 may partition the data into time series snippets, like the one second snippets, as discussed above.

At block 315, receiver 260 may analyze the snippets and transform snippet values into feature values, like the 1,000 frequency domain feature values. Initially, the transform may be a generalized transform based on a default or template. Alternatively, the initial transform may be generated via a training phase, whereby a user of sender 250 trains the system to optimize the transform for that particular user.

With learned metrics for a person's voice, the system can identify and suppress noisy snippets that don't contain the known voice pattern, and enhance the person's voice while suppressing noise in snippets that contain both voice and noise. Learned weights may also be used to impute voice features that may not have been transmitted. For example in method 900A, available bandwidth may allow time series data to be transmitted at 20 KHz to 10 KHz. In that case, learned weights for imputing higher frequency components for a person from that person's lower frequency components may be used to enhance his or her voice, even though the higher frequency components could not be reproduced from the arriving signal.

During operation, the 1,000 frequency domain feature values may be adaptively changed as the system obtains more recording samples. This provides for a more dynamic system based on changing conditions. Therefore, at block 320, receiver 460 may update learned feature metrics and thereby adjust the transform for converting the 20 k frequency values to 1000 frequency values.

At block 325, receiver 260 may reconfigure the transform and inverse transform functions according to the most recent learned metrics.

At block 330, receiver 260 may inverse transform the feature values for the snippet back into the time domain, so that the reproduced sound resembles the voice of the sender's 450 user.

Finally, at block 335, receiver 260 may play or display the reproduced time series values as appropriate.

Under method 300A, receiver 250 may filter out clutter frequency components, but the overall system would not reduce the amount of transmitted data.

FIG. 9B illustrates an example method 300B, where sender 250 and receiver 260 may divide the data processing to both filter out clutter and reduce the amount of transmitted data. The blocks represented in method 300B are similar to the corresponding blocks in method 300A. However, by shifting the processing to sender 250, the amount of data transferred between sender 250 and receiver 260 may be significantly reduced.

In method 300B, sender 250 may record the time series data (at block 305), partition the data into snippets (at block 310), transform the snippet values to feature values (at block 315), and transmit the feature values to receiver 260. Receiver 260 may inverse transform feature values into the time domain (at block 330) and reproduce the time series data (at block 335).

The sender unit 250 may also continuously update feature salience values (at block 320), reconfigure data reduction transforms (at block 325) and transmit reconfigured transform values to the receiver 260 in order to ensure proper time domain recovery. However, sender 250 may only need to occasionally send updated learned metrics or transforms to receiver 260 on an as-needed basis as the system optimizes the transforms based on the recorded time series data.

At block 325, the receiver may then play or display the reproduced time series data.

FIG. 9C illustrates a third example method 300C, where filtering and clutter reduction will occur without data reduction, as with method 300A. However, unlike method 300A, in method 300C the filtering and clutter reduction will occur at sender unit 250, instead of at receiver unit 260. Particularly, in FIG. 9C, the transmission occurs after the inverse transform of the data to the time domain. While the transmission may be improved to remove noise from the transmitted signal in the final signal before reproduction, the system does not benefit from the transmission of the simplified feature values.

FIG. 9D illustrates a fourth method 900D, similar to method 900C, where the sender unit 460 will also inverse transform the feature values into the time domain, and then play or display the reproduced time series values locally as well as transmit the reproduced time series to receiver 460.

Available voice recognition and synthesis technology may be coupled with example embodiments to deliver affordable and valuable voice data reduction and filtering solutions. For example, currently available technology can efficiently convert voice data to text data, resulting in data reduction factors of about 1,000 from radio quality data (assuming that an individual says about 120, eight character words per minute). The text may then be transmitted, along with a feature configuration packet. The configuration packet would indicate features that receiver 260 should use to reproduce the caller's voice.

The features in this case would not be FFTs, but state-of the art features for reproducing a person's voice from text. Any variety of features can be used as well for greater efficiency, such as orthogonal counterparts to FFTs that can be transformed and inverse transformed linearly. Closely held features may be used as well, allowing time series to be encrypted before transmission and then decrypted after transmission.

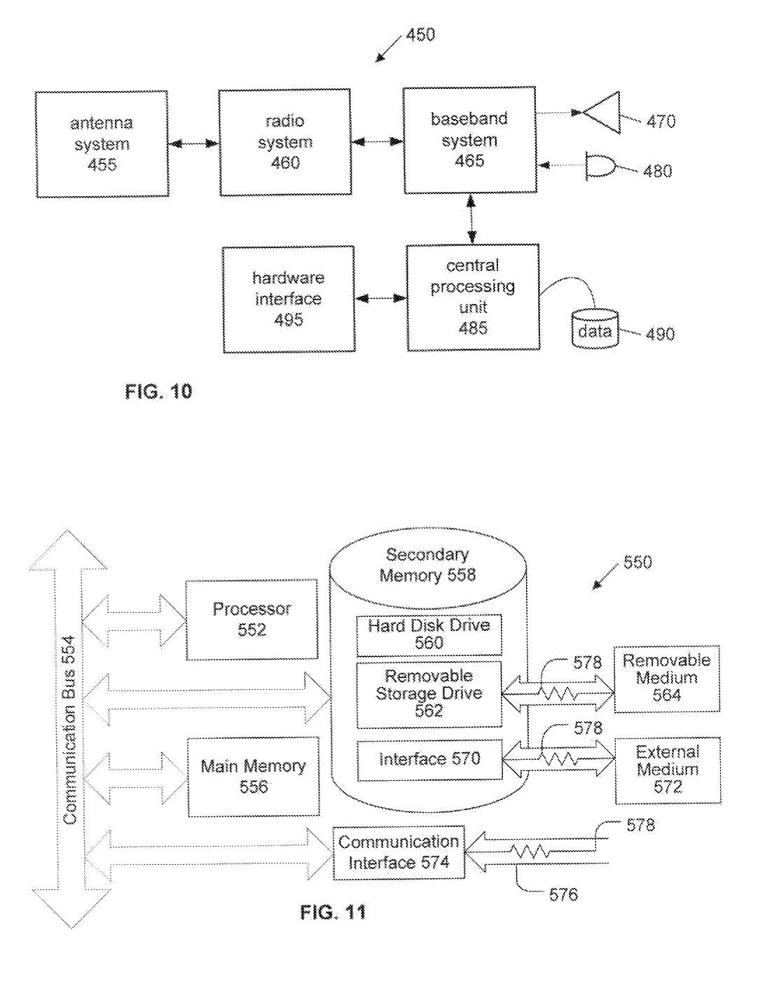

FIG. 10 is a block diagram illustrating an example wireless communication device 450 that may be used in connection with various embodiments described herein. For example, the wireless communication device 450 may be used in conjunction with sender 250 and receiver 260 to transmit or receive data. However, other wireless communication devices and/or architectures may also be used, as will be clear to those skilled in the art.

In the illustrated embodiment, wireless communication device 450 comprises an antenna system 455, a radio system 460, a baseband system 465, a speaker 470, a microphone 480, a central processing unit (“CPU”) 485, a data storage area 490, and a hardware interface 495. In the wireless communication device 450, radio frequency (“RF”) signals are transmitted and received over the air by the antenna system 455 under the management of the radio system 460.

In one embodiment, the antenna system 455 may comprise one or more antennae and one or more multiplexors (not shown) that perform a switching function to provide the antenna system 455 with transmit and receive signal paths. In the receive path, received RF signals can be coupled from a multiplexor to a low noise amplifier (not shown) that amplifies the received RF signal and sends the amplified signal to the radio system 460.

In alternative embodiments, the radio system 460 may comprise one or more radios that are configured for communication over various frequencies. In one embodiment, the radio system 460 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 460 to the baseband system 465.

If the received signal contains audio information, then baseband system 465 decodes the signal and converts it to an analog signal. Then the signal is amplified and sent to the speaker 470. The baseband system 465 also receives analog audio signals from the microphone 480. These analog audio signals are converted to digital signals and encoded by the baseband system 465. The baseband system 465 also codes the digital signals for transmission and generates a baseband transmit audio signal that is routed to the modulator portion of the radio system 460. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 455 where the signal is switched to the antenna port for transmission.

The baseband system 465 is also communicatively coupled with the central processing unit 485. The central processing unit 485 has access to a data storage area 490. The central processing unit 485 is preferably configured to execute instructions (i.e., computer programs or software) that can be stored in the data storage area 490. Computer programs can also be received from the baseband processor 465 and stored in the data storage area 490 or executed upon receipt. Such computer programs, when executed, enable the wireless communication device 450 to perform the various functions of the present invention as previously described. For example, data storage area 490 may include various software modules (not shown) necessary to implement the disclosed methods.

In this description, the term “computer readable medium” is used to refer to any among many available media used to provide executable instructions (e.g., software and computer programs) to the wireless communication device 450 for execution by the central processing unit 485. Examples of these media include the data storage area 490, microphone 480 (via the baseband system 465), antenna system 455 (also via the baseband system 465), and hardware interface 495. These computer readable media are means for providing executable code, programming instructions, and software to the wireless communication device 450. The executable code, programming instructions, and software, when executed by the central processing unit 485, preferably cause the central processing unit 485 to perform the inventive features and functions previously described herein.

The central processing unit 485 is also preferably configured to receive notifications from the hardware interface 495 when new devices are detected by the hardware interface. Hardware interface 495 can be a combination electromechanical detector with controlling software that communicates with the CPU 485 and interacts with new devices. The hardware interface 495 may be a firewire port, a USB port, a Bluetooth or infrared wireless unit, or any of a variety of wired or wireless access mechanisms. Examples of hardware that may be linked with the device 450 include data storage devices, computing devices, headphones, microphones, and the like.

FIG. 11 is a block diagram illustrating an example computer system 550 that may be used in connection with various embodiments described herein. For example, the computer system 550 may be used in conjunction with sender 150 or 250 and receiver 160 or 260 to process time series data. However, other computer systems and/or architectures may be used, as will be clear to those skilled in the art.

The computer system 550 preferably includes one or more processors, such as processor 552. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 552.

The processor 552 is preferably connected to a communication bus 554. The communication bus 554 may include a data channel for facilitating information transfer between storage and other peripheral components of the computer system 550. The communication bus 554 further may provide a set of signals used for communication with the processor 552, including a data bus, address bus, and control bus (not shown). The communication bus 554 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

Computer system 550 preferably includes a main memory 556 and may also include a secondary memory 558. The main memory 556 provides storage of instructions and data for programs executing on the processor 552. The main memory 556 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 558 may optionally include a hard disk drive 560 and/or a removable storage drive 562, for example a floppy disk drive, a magnetic tape drive, a compact disc (“CD”) drive, a digital versatile disc (“DVD”) drive, etc. The removable storage drive 562 reads from and/or writes to a removable storage medium 564 in a well-known manner. Removable storage medium 564 may be, for example, a floppy disk, magnetic tape, CD, DVD, etc.

The removable storage medium 564 is preferably a computer readable medium having stored thereon computer executable code (i.e., software) and/or data. The computer software or data stored on the removable storage medium 564 is read into the computer system 550 as electrical communication signals 578.

In alternative embodiments, secondary memory 558 may include other similar means for allowing computer programs or other data or instructions to be loaded into the computer system 550. Such means may include, for example, an external storage medium 572 and an interface 570. Examples of external storage medium 572 may include an external hard disk drive or an external optical drive, or and external magneto-optical drive.

Other examples of secondary memory 558 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage units 572 and interfaces 570, which allow software and data to be transferred from the removable storage unit 572 to the computer system 550.

Computer system 550 may also include a communication interface 574. The communication interface 574 allows software and data to be transferred between computer system 550 and external devices (e.g. printers), networks, or information sources. For example, computer software or executable code may be transferred to computer system 550 from a network server via communication interface 574. Examples of communication interface 574 include a modem, a network interface card (“NIC”), a communications port, a PCMCIA slot and card, an infrared interface, and an IEEE 1394 fire-wire, just to name a few.

Communication interface 574 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 574 are generally in the form of electrical communication signals 578. These signals 578 are preferably provided to communication interface 574 via a communication channel 576. Communication channel 576 carries signals 578 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 556 and/or the secondary memory 558. Computer programs can also be received via communication interface 574 and stored in the main memory 556 and/or the secondary memory 558. Such computer programs, when executed, enable the computer system 550 to perform the various functions of the present invention as previously described.

In this description, the term “computer readable medium” is used to refer to any media used to provide computer executable code (e.g., software and computer programs) to the computer system 550. Examples of these media include main memory 556, secondary memory 558 (including hard disk drive 560, removable storage media 564, and external storage medium 572), and any peripheral device communicatively coupled with communication interface 574 (including a network information server or other network device). These computer readable media are means for providing executable code, programming instructions, and software to the computer system 550.

In an embodiment that is implemented using software, the software may be stored on a computer readable medium and loaded into computer system 550 by way of removable storage drive 562, interface 570, or communication interface 574. In such an embodiment, the software is loaded into the computer system 550 in the form of electrical communication signals 578. The software, when executed by the processor 552, preferably causes the processor 552 to perform the inventive features and functions previously described herein.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A technical system for reducing data within a data stream, the system comprising:
a computer readable storage medium for storing computer executable programmed modules;
a processor communicatively coupled with the computer readable storage medium for executing programmed modules stored therein;
a partitioning module stored in the computer readable storage medium and configured to divide a time series data into a plurality of slices;
a transform module stored in the computer readable storage medium and configured to transform data within one or more slices into a plurality of feature values;
an inverse transform module stored in the computer readable storage medium and configured to transform a plurality of feature values to a slice of time series data;
an reproduction module stored in the computer readable storage medium and configured to reproduce the time series data by combining the plurality of slice of time series data.

2. A technical system for reducing data within a data stream, the system comprising:
a computer readable storage medium for storing computer executable programmed modules;
a processor communicatively coupled with the computer readable storage medium for executing programmed modules stored therein;
a partitioning module stored in the computer readable storage medium and configured to divide a time series data into a plurality of slices;
a transform module stored in the computer readable storage medium and configured to transform data within one or more slices into a plurality of feature values;
an inverse transform module stored in the computer readable storage medium and configured to transform a plurality of feature values to a slice of time series data;
an reproduction module stored in the computer readable storage medium and configured to reproduce the time series data by combining the plurality of slice of time series data;
a recording module stored in the computer readable storage medium and configured to record time series data in the form of a plurality images; and
wherein the slices of time series data comprise multiple windows of image data generated by dividing the image data in a predetermined number of smaller images.

3. The technical system of claim 2, further comprising a masking module stored in the computer readable storage medium and configured to identify non-useful data in a slice by comparing the feature values from the slice to predetermined value ranges.

4. The technical system of claim 3, further comprising a identification module stored in the computer readable storage medium and configured to identify useful data in a slice by comparing the feature values from the slice to predetermined value ranges.

5. A technical system for reducing data within a data stream, the system comprising:
a computer readable storage medium for storing computer executable programmed modules;
a processor communicatively coupled with the computer readable storage medium for executing programmed modules stored therein;
a partitioning module stored in the computer readable storage medium and configured to divide a time series data into a plurality of slices;
a transform module stored in the computer readable storage medium and configured to transform data within one or more slices into a plurality of feature values;
an inverse transform module stored in the computer readable storage medium and configured to transform a plurality of feature values to a slice of time series data;
an reproduction module stored in the computer readable storage medium and configured to reproduce the time series data by combining the plurality of slice of time series data;
a recording module stored in the computer readable storage medium and configured to record time series data in the form of a plurality audio data; and
wherein the slices of time series data comprise audio data a partitioned by time periods.

6. The technical system of claim 5, further wherein the transform module transforms the audio slice data into feature values associated with a predetermined frequency range.

7. The technical system of claim 6, further wherein the inverse transform module transforms the feature values into frequency data associated with the predetermined frequency range.

8. The technical system of claim 6, further wherein a predetermined frequency range is associated with audio noise.

9. (canceled)

10. A system comprising at least one processor communicatively coupled with at least one computer readable storage medium, wherein the processor is programmed to reduce data within a data stream by:
partitioning a time series data into a plurality of slices;
transforming data within one or more slices into a plurality of feature values;
inverse transforming a plurality of feature values to a slice of time series data;
reproducing the time series data by combining the plurality of slice of time series data;
recording time series data in the form of a plurality of images; and
wherein the slices of time series data comprise multiple windows of image data generated by dividing the image data in a predetermined number of smaller images.

11. The system of claim 10, further comprising masking non-useful data in a slice by comparing the feature values from the slice to predetermined value ranges and masking slice data corresponding to feature values outside the predetermined value ranges.

12. The system of claim 11, further comprising identifying useful data in a slice by comparing the feature values from the slice to predetermined value ranges.

13. A system comprising at least one processor communicatively coupled with at least one computer readable storage medium, wherein the processor is programmed to reduce data within a data stream by:
partitioning a time series data into a plurality of slices;
transforming data within one or more slices into a plurality of feature values;
inverse transforming a plurality of feature values to a slice of time series data;
reproducing the time series data by combining the plurality of slice of time series data;
recording time series data in the form of a plurality of audio data; and
wherein the slices of time series data comprise audio data partitioned by time periods.

14. The system of claim 13, further wherein the transform module transforms the audio slice data into feature values associated with a predetermined frequency range.

15. The system of claim 14, further wherein the inverse transforming includes transforming the feature values into frequency data associated with the predetermined frequency range.

16. The system of claim 13, further wherein a predetermined frequency range is associated with audio noise.

17. (canceled)

18. A computer implemented method for reducing noise and data size, where one or more processors are programmed to perform steps comprising:
partitioning a time series data into a plurality of slices;
transforming data within one or more slices into a plurality of feature values;
inverse transforming a plurality of feature values to a slice of time series data;
reproducing the time series data by combining the plurality of slice of time series data;
recording time series data in the form of a plurality of images; and
wherein the slices of time series data comprise multiple windows of image data generated by dividing the image data in a predetermined number of smaller images.

19. A computer implemented method for reducing noise and data size, where one or more processors are programmed to perform steps comprising:
partitioning a time series data into a plurality of slices;
transforming data within one or more slices into a plurality of feature values;
inverse transforming a plurality of feature values to a slice of time series data;
reproducing the time series data by combining the plurality of slice of time series data;
recording time series data in the form of a plurality of audio data; and
wherein the slices of time series data comprise audio data a partitioned by time periods.

20. The system of claim 19, further wherein the transform module transforms the audio slice data into feature values associated with a predetermined frequency range.
